(19) United States
(12) Patent Application Publication
(10) Pub. No.: US 2026/0029966 A1
(43) Pub. Date: Jan. 29, 2026

(54) SELECTIVE IMPLEMENTATION OF A REDUNDANT ARRAY OF INDEPENDENT NAND PROCEDURE

(71) Applicant: Micron Technology, Inc., Boise, ID (US)

(72) Inventors: Lei ZHANG, Singapore (SG); Yi Lin LAI, New Taipei City (TW)

(21) Appl. No.: 18/787,120

(22) Filed: Jul. 29, 2024

(51) Int. Cl. G06F 3/06

(52) U.S. Cl. CPC G06F 3/0688; G06F 3/0604; G06F 3/0655

(57) ABSTRACT

In some implementations, a memory system controller may receive host data to be written to a portion of a non-volatile memory. The memory system controller may determine, for the host data, a first set of parity information that is associated with a first redundant array of non-volatile memory devices procedure. The memory system controller may determine whether the portion of the non-volatile memory is associated with a second redundant array of non-volatile memory devices procedure different from the first redundant array of non-volatile memory devices procedure. If it is determined that the portion of the non-volatile memory is associated with the second redundant array of non-volatile memory devices procedure, the memory system controller may determine, for the host data, a second set of parity information that is associated with the second redundant array of non-volatile memory devices procedure.

### TECHNICAL FIELD

The present disclosure generally relates to memory devices, memory device operations, and, for example, to selective implementation of a redundant array of independent NAND (RAIN) procedure.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some cases, a memory device may be associated with one or more error protection schemes. For example, a memory device may be associated with a redundant array of independent memory scheme, such as a RAIN scheme in cases in which a memory device is associated with NAND memory.

### BRIEF DESCRIPTION OF THE DRAWINGS

FIG. 1 is a diagram illustrating an example system capable of selective implementation of a RAIN procedure.

FIGS. 2A-2D are diagrams of examples associated with various RAIN procedures.

FIGS. 3A-3B are diagrams of examples associated with selective implementation of a RAIN procedure.

FIG. 4 is a flowchart of an example method associated with selective implementation of a RAIN procedure.

FIG. 5 is a flowchart of another example method associated with selective implementation of a RAIN procedure.

FIG. 6 is a flowchart of another example method associated with selective implementation of a RAIN procedure.

### DETAILED DESCRIPTION

Solid-state drives (SSDs) are important components in modern computing, providing faster data access and greater reliability than traditional hard disk drives (HDDs). In some examples, SSDs and similar memory systems may be protected by certain error protection schemes, such as RAIN schemes or similar redundant array of non-volatile memory schemes. However, selecting the appropriate RAIN technology for SSDs may pose a challenge. For example, RAIN technologies may include technologies known as die RAIN, block RAIN, and/or two-word-line (2WL) RAIN, among other examples. Die RAIN may offer robust data protection, but may require significant storage overhead. Block RAIN may provide less protection than die RAIN, with a reduction in storage overhead, but may not be sufficient in scenarios where increased defect coverage is necessary. 2WL RAIN, while more efficient than die RAIN and block RAIN in terms of storage usage, may provide less protection than both die RAIN and block RAIN and thus may be susceptible to certain types of defects.

Some implementations described herein enable improved defect coverage and data protection in SSDs or similar memory systems, such as by employing a certain RAIN procedure (e.g., a block RAIN procedure) for selective blocks without significantly affecting storage efficiency. In some implementations, a memory system may perform a first RAIN procedure (e.g., 2WL RAIN) for all portions of a memory (e.g., a NAND memory), and may apply a second RAIN procedure (e.g., block RAIN) for portions of the memory susceptible to defects, among other examples. In such implementations, the memory system may determine the appropriate level of protection (e.g., may determine whether the second RAIN procedure is to be used) based on certain criteria associated with a portion of memory being written to, such as a program-erase cycle (PEC) count associated with the portion of the memory, error recovery statistics (ERS) associated with the portion of the memory, a raw bit error rate (RBER) associated with the portion of the memory, and/or similar criteria. By optimizing the use of NAND memory space and utilizing non-budgeted spare blocks for storing block RAIN parity information, the implementations described herein may conserve memory resources while improving the quality and reliability of the memory system. Moreover, the implementations described herein may take advantage of existing spare capacity within the SSD architecture, ensuring no detrimental effects on performance and memory allocation. In some implementations, the techniques described herein may enable conditional application of advanced RAIN procedures in addition to standard RAIN procedures (e.g., 2WL RAIN procedures) in low-density SSDs that may require a fine balance between format efficiency and augmented protection. In this way, the techniques described herein may enhance the quality and reliability of memory systems such as SSDs, while reducing memory resource overhead associated with certain traditional error protection schemes.

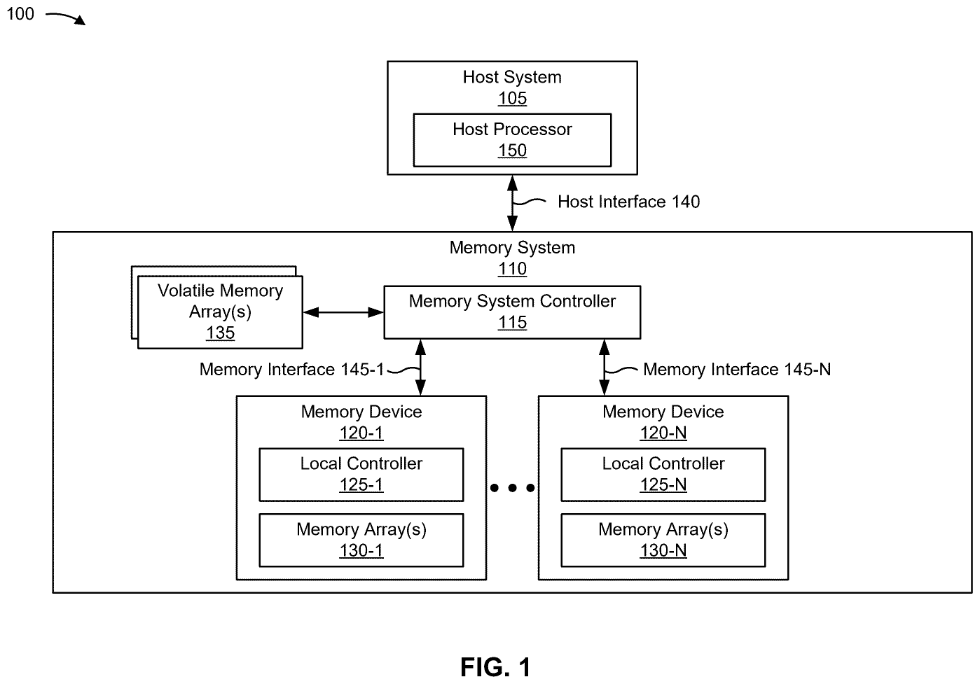

FIG. 1 is a diagram illustrating an example system 100 capable of selective implementation of a RAIN procedure. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IOT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, an SSD, a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (cMMC) device, a dual in-line memory module (DIMM), a compute express link (CXL) memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from a host system, host data to be written to a portion of a NAND memory; determine, for the host data, a first set of parity information that is associated with a first RAIN procedure; determine whether the portion of the NAND memory is associated with a second RAIN procedure different from the first RAIN procedure; and perform one of: determine, for the host data, a second set of parity information that is associated with the second RAIN procedure when it is determined that the portion of the NAND memory is associated with the second RAIN procedure; or omit determination of the second set of parity information when it is determined that the portion of the NAND memory is not associated with the second RAIN procedure.

In some implementations, one or more systems, devices, apparatuses, components, and/or controllers of FIG. 1 may be configured to receive, from a host system, host data to be written to a portion of a non-volatile memory associated with a memory system; determine, for the host data, a first set of parity information that is associated with a first redundant array of non-volatile memory devices procedure; determine whether the portion of the non-volatile memory is associated with a second redundant array of non-volatile memory devices procedure different from the first redundant array of non-volatile memory devices procedure; and perform one of: determine, for the host data, a second set of parity information that is associated with the second redundant array of non-volatile memory devices procedure when it is determined that the portion of the non-volatile memory is associated with the second redundant array of non-volatile memory devices procedure; or forgo determination of the second set of parity information when it is determined that the portion of the non-volatile memory is not associated with the second redundant array of non-volatile memory devices procedure.

In some implementations, one or more systems, devices, apparatuses, components, and/or controllers of FIG. 1 may be configured to receive data to be written to a portion of a memory; determine, for the data, a first set of parity information that is associated with a first redundant array of independent memory procedure; determine whether the portion of the memory is associated with a second redundant array of independent memory procedure different from the first redundant array of independent memory procedure; and perform one of: determine, for the data, a second set of parity information that is associated with the second redundant array of independent memory procedure when it is determined that the portion of the memory is associated with the second redundant array of independent memory procedure; or omit determination of the second set of parity information when it is determined that the portion of the memory is not associated with the second redundant array of independent memory procedure.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

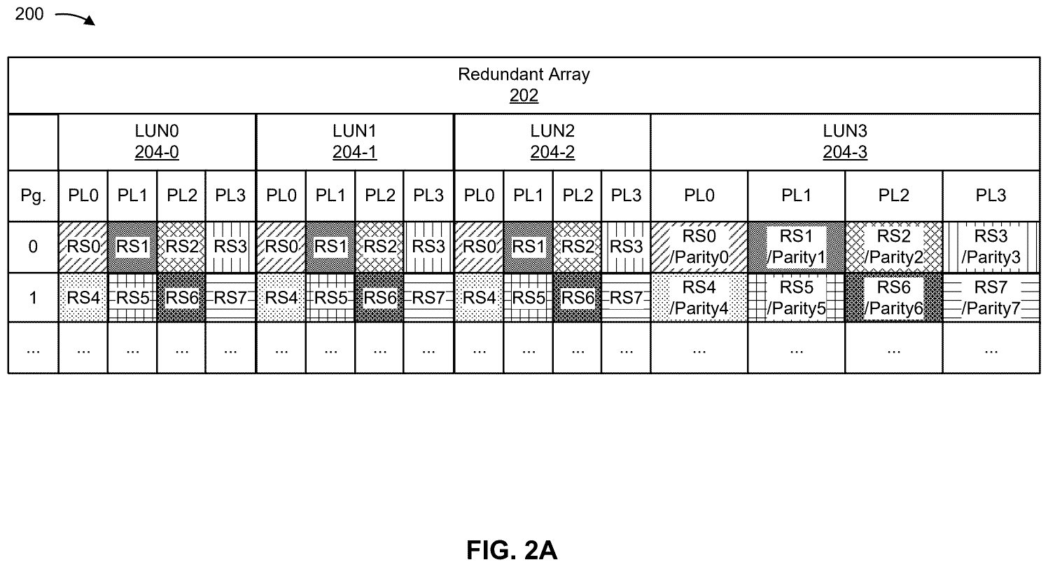

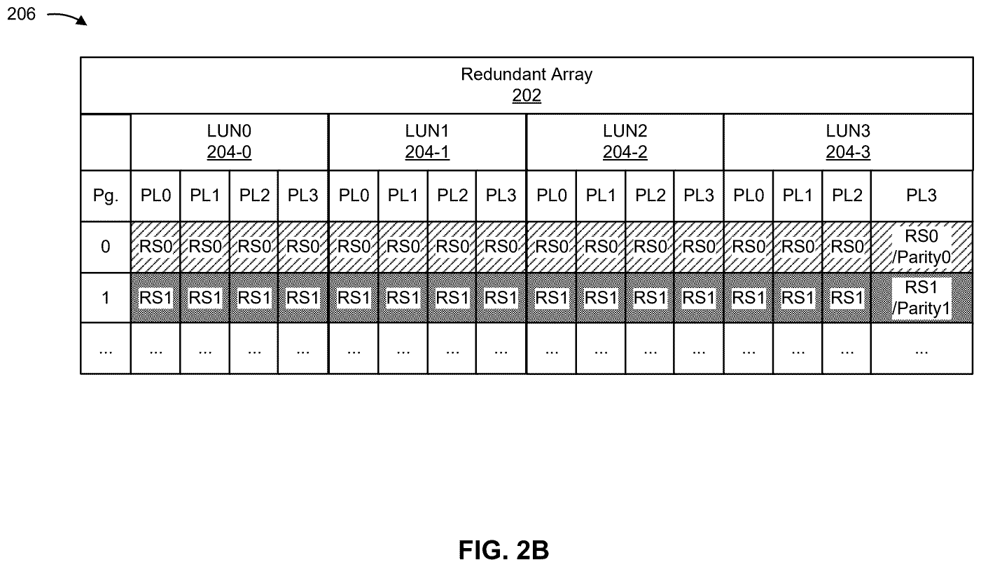

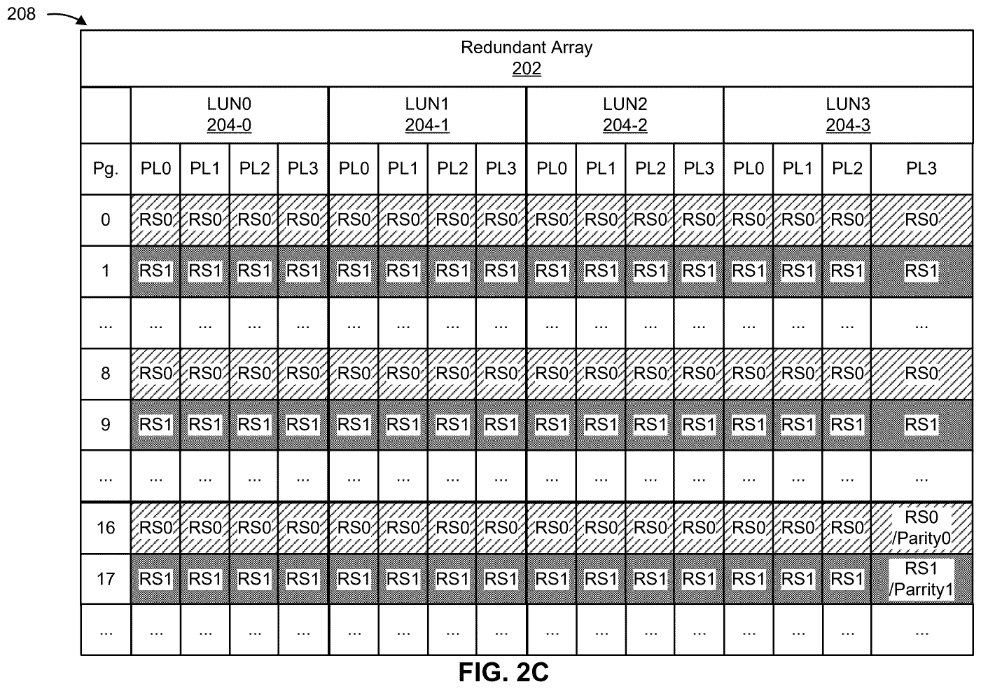

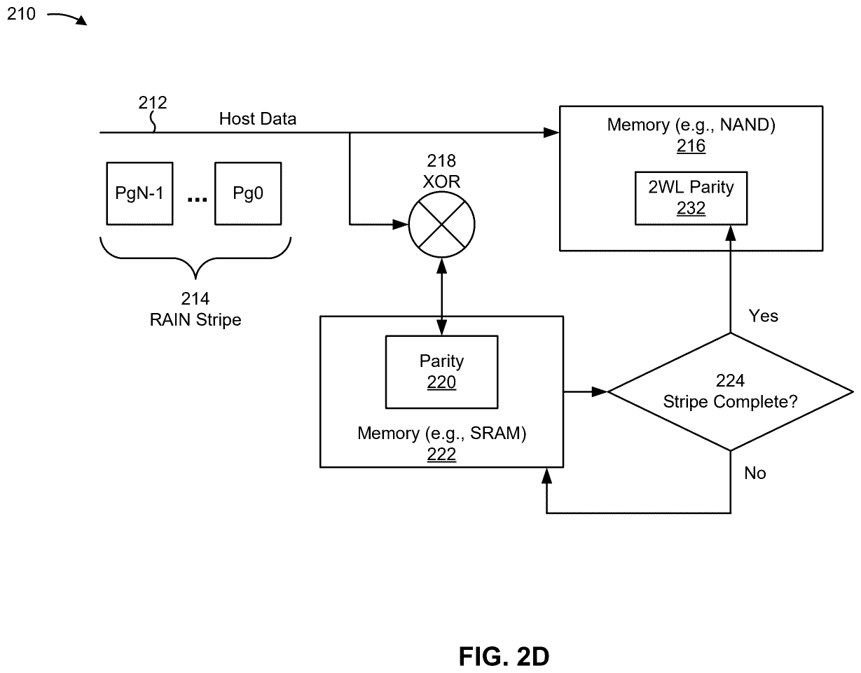

FIGS. 2A-2D are diagrams of examples associated with various RAIN procedures. The operations described in connection with FIGS. 2A-2D may be performed by the memory system 110 and/or one or more components of the memory system 110, such as the memory system controller 115, one or more memory devices 120, and/or one or more local controllers 125.

A redundant array of independent memory procedure (sometimes referred to herein as a redundant array of independent memory scheme, a redundant array of non-volatile memory devices scheme and/or procedure, and/or a similar term), such as a RAIN procedure, a redundant array of independent disks (RAID) procedure, and/or a similar procedure, is a technology that may be used to protect the data integrity in a memory system, such as an SSD and/or a similar memory system. In some examples, different types of RAIN procedures may be associated with different levels of protection. For example, some RAIN procedures may be referred to as die RAIN procedures, block RAIN procedures, and/or 2WL RAIN procedures, among other examples. In such cases, a die RAIN procedure may provide the highest protection coverage at a cost of high storage overhead. On the other hand, a 2WL RAIN procedure may provide the lowest protection coverage, but may be the most efficient of the three RAIN procedures (e.g., may be associated with the lowest storage overhead). In the middle, block RAIN may be more efficient than die RAIN but may provide reduced protection as compared to die RAIN, and/or may be less efficient than 2WL RAIN while providing a higher level of protection than 2WL RAIN.

As shown in FIG. 2A, and as indicated by reference number 200, a RAIN procedure may be associated with a redundant array 202 of memory devices, which are sometimes referred to as dies and/or logical unit numbers (LUNs) 204. For case of discussion, the redundant array 202 is associated with four LUNs 204 (e.g., four dies, shown as a first LUN 204-0, sometimes referred to as LUNO, through a fourth LUN 204-3, sometimes referred to a LUN3), with each LUN 204 in turn being associated with four planes (PLs) (indexed in FIG. 2A as PL0 through PL3). In some other examples, a redundant array of memory devices may be associated with more or fewer memory devices (e.g., LUNs), and/or each memory device may be associated with more or fewer planes, without departing from the scope of the disclosure.

The example indicated by reference number 200 is associated with a die RAIN procedure, in which pages from respective planes of each LUN 204 may form a separate parity group (sometimes referred to as a parity codeword). More particularly, and indicated using like-shading in FIG. 2A, page 0 of PL0 of each LUN 204 may form a first parity group (with pages 0 of the first LUN 204-0 through the third LUN 204-2 storing data bits, and with page 0 of the fourth LUN 204-3 storing parity bits), page 0 of PL1 of each LUN 204 may form a second parity group (again with page 0 of the first LUN 204-0 through the third LUN 204-2 storing data bits, and with page 0 of the fourth LUN 204-3 storing parity bits), and so forth, through page 1 of PL3 of each LUN 204 forming an eighth parity group. A parity group may be referred to herein as a RAIN parity stripe, or, more simply, a RAIN stripe. Aspects of generating parity for a given RAIN stripe are described in more detail below in connection with FIG. 2D.

Additionally, or alternatively, each parity group may be associated with a Reed-Solomon (RS) code and/or an RS codeword. In such examples, the first three LUNs 204 may store data bits of the RS codeword (sometimes referred to as the payload of the RS codeword), and the fourth LUN 204-3 may store the parity bits of the RS codeword. For example, with respect to the parity group associated with the page 0 of PL0, the first LUN 204-0, second LUN 204-1, and third LUN 204-2 may store data bits used as a payload of a first RS codeword (and thus labeled “RS0”), and the fourth LUN 204-3 may store parity bits used as parity information for the first RS codeword (and thus labeled “RS0/Parity0”). In some other examples, a different type of code and/or codeword may be used without departing from the scope of the disclosure.

In that regard, for the die RAIN example described above, the overhead of parity pages versus data pages is 1:3. Put another way, for every three pages of data, one page of parity information is required. Accordingly, die RAIN may be associated with a relatively high overhead, because 25% of the storage is used for purposes of storing parity information. However, die RAIN may be associated with a relatively high level of protection. This is because each LUN 204 only stores one page of information associated with any given RAIN stripe, and the parity information (e.g., RS parity information) may be capable of correcting up to one page of errors. Accordingly, die RAIN may be capable of protecting data even in a case of an entire die failure. For example, if the first LUN 204-0 were to fail, a memory system employing die RAIN would be capable of recovering the data stored at page 0 of PL0 using the data stored at information stored at page 0 of PL0 of the fourth LUN 204-3, the data stored at page 0 of PL1 using the data stored at page 0 of PL1 of the second LUN 204-1 and the third LUN 204-2 as well as the parity information stored at page 0 of PL1 of the fourth LUN 204-3, and so forth, through recovery of the data stored at page 1 of PL3 of the first LUN 204-0 using the data stored at page 1 of PL3 of the second LUN 204-1 and the third LUN 204-2 as well as the parity information stored at page 1 of PL3 of the fourth LUN 204-3.

Because die RAIN is associated with a relatively high storage overhead, some memory systems may use certain other RAIN procedures to improve efficiency of the error protection schemes, albeit at a reduced protection level as compared to die RAIN. For example, as shown in FIG. 2B, and as indicated by reference number 206, in some other examples the redundant array 202 may be associated with a block RAIN procedure in which pages from a same superpage form a separate parity group (e.g., a separate parity codeword). As used herein, “superpage” refers to a group of all pages in all planes of all dies that share a same page index. In that regard, the sixteen pages associated with page 0 in the example shown in FIG. 2B form a first superpage and the sixteen pages associated with page 1 in the example shown in FIG. 2B form a second superpage. Accordingly, and as indicated using like-shading in FIG. 2A, page 0 of PL0 of the first LUN 204-0 through page 0 of PL3 of the fourth LUN 204-3 may form a first parity group (with page 0 of PL0 of the first LUN 204-0 through page 0 of PL2 of the fourth LUN 204-3 storing data bits, and with page 0 of PL3 of the fourth LUN 204-3 storing parity bits), and with page 1 of PL0 of the first LUN 204-0 through page 1 of PL2 of the fourth LUN 204-3 forming a second parity group (with page 1 of PL0 of the first LUN 204-0 through page 1 of PL2 of the fourth LUN 204-3 storing data bits, and with page 1 of PL3 of the fourth LUN 204-3 storing parity bits).

In examples in which each parity group (e.g., each RAIN stripe) is associated with an RS codeword, the first fifteen pages of each superpage may store data bits of the RS codeword (e.g., the payload of the RS codeword), and the last page of each superpage may store the parity bits of the RS codeword. For example, with respect to the parity group associated with page 0, page 0 of PL0 of the first LUN 204-0 through page 0 of PL2 of the fourth LUN 204-3 may store data bits used as a payload of a first RS codeword (and thus labeled “RS0”), and page 0 of PL3 of the fourth LUN 204-3 may store parity bits used as parity information for the first RS codeword (and thus labeled “RS0/Parity0”). Similarly, with respect to the parity group associated with page 1, page 1 of PL0 of the first LUN 204-0 through page 1 of PL2 of the fourth LUN 204-3 may store data bits used as a payload of a second RS codeword (and thus labeled “RS1”), and page 1 of PL3 of the fourth LUN 204-3 may store parity bits used as parity information for the second RS codeword (and thus labeled “RS1/Parity1”).

In that regard, for the block RAIN example described above, the overhead of parity pages versus data pages is 1:15. Put another way, for every fifteen pages of data, one page of parity information is required. Accordingly, block RAIN may be associated with a reduced overhead as compared to die RAIN, because only 6.25% of the storage may be used for purposes of storing parity information (compared to 25% needed for die RAIN). However, block RAIN may be associated with a lower level of protection as compared to die RAIN. This is because, unlike die RAIN, which may be capable of protecting data even in a case of an entire die failure, block RAIN may be capable of protecting data only up to a case of a plane failure.

In some examples, other RAIN procedures may be used to achieve even greater storage efficiencies at a cost of reduced protection as compared to die RAIN and/or block RAIN. For example, as shown in FIG. 2C, and as indicated by reference number 208, the redundant array 202 may be associated with a 2WL RAIN procedure, in which multiple superpages form a single parity group (e.g., a parity codeword). More particularly, in the example indicated by reference number 208, three superpages form one parity group. For example, all pages associated with page 0, page 8, and page 16 may form a first parity group (with page 0 of PL0 of the first LUN 204-0 through page 16 of PL2 of the fourth LUN 204-3 storing data bits, and with page 16 of PL3 of the fourth LUN 204-3 storing parity bits). Similarly, all pages associated with page 1, page 9, and page 17 may form a second parity group (with page 1 of PL0 of the first LUN 204-0 through page 17 of PL2 of the fourth LUN 204-3 storing data bits, and with page 17 of PL3 of the fourth LUN 204-3 storing parity bits).

In examples in which each parity group (e.g., each RAIN stripe) is associated with an RS codeword, the first 47 pages of each parity group may store data bits of the RS codeword (e.g., the payload of the RS codeword), and the last page of each parity group may store the parity bits of the RS codeword. For example, with respect to the parity group associated with pages 0, 8, and 16, page 0 of PL0 of the first LUN 204-0 through page 16 of PL2 of the fourth LUN 204-3 may store data bits used as a payload of a first RS codeword (and thus labeled “RS0”), and page 16 of PL3 of the fourth LUN 204-3 may store parity bits used as parity information for the first RS codeword (and thus labeled “RS0/Parity0”). Similarly, with respect to the parity group associated with pages 1, 9, and 17, page 1 of PL0 of the first LUN 204-0 through page 17 of PL2 of the fourth LUN 204-3 may store data bits used as a payload of a second RS codeword (and thus labeled “RS1”), and page 17 of PL3 of the fourth LUN 204-3 may store parity bits used as parity information for the second RS codeword (and thus labeled “RS1/Parity1”).

In that regard, for the 2WL RAIN example described above, the overhead of parity pages versus data pages is 1:47. Put another way, for every 47 pages of data, one page of parity information is required. Accordingly, 2WL RAIN may be associated with a reduced overhead as compared to die RAIN and block RAIN, because only approximately 2.08% of the storage may be used for purposes of storing parity information (compared to 25% needed for die RAIN and the 6.25% needed for block RAIN). However, 2WL RAIN may be associated with a lower level of protection as compared to die RAIN and/or block RAIN. This is because, unlike die RAIN, which may be capable of protecting data even in a case of an entire die failure, or block RAIN, which may be capable of protecting data even in a case of an entire plane failure, 2WL RAIN may be capable of protecting data only up to 2WL of data. Put another way, for 2WL RAIN, the superpages from different WLs may be selected to protect against defectivity to multiple pages of the same WL, resulting in protection limited to defectivity that spans less than or equal to 2WL. Accordingly, in some examples, 2WL RAIN may be vulnerable to pillar-related failures, among other defects.

FIG. 2D shows an example 210 associated with the general flow for parity generation, such as generation of parity information (e.g., parity bits of a codeword) associated with a 2WL RAIN procedure, among other examples. As indicated by reference number 212, as host data is received at a memory system, pages of data belonging to a same parity group (e.g., a same RAIN stripe 214) may be stored in a memory 216 (e.g., a NAND memory, such as in a data portion of the LUNs 204 described above in connection with FIGS. 2A-2C) as well as fed to an exclusive or (XOR) engine 218. The XOR engine 218 may perform an XOR operation using the pages of host data as input. More particularly, the XOR engine 218 may continuously update parity information 220 stored in a local memory 222 (e.g., SRAM) as the host data is fed to the XOR engine 218, such as by performing an XOR operation in a bitwise fashion using the various pages of host data as input. As indicated by reference number 224, the memory system will wait until the entire RAIN stripe 214 is received and/or fed to the XOR engine 218 before moving the parity information from the local memory 222 (e.g., SRAM) to the memory 216 (e.g., NAND). Once the RAIN stripe 214 is complete (e.g., once all host data for the RAIN stripe 214 has been provided to the XOR engine 218 and thus the XOR engine 218 has fully generated the parity information for the RAIN stripe 214), the parity information may be stored in the memory 216 (e.g., NAND). For example, in examples associated with a 2WL RAIN procedure, the 2WL parity information 232 may be stored at a portion of the memory 216 used to store the parity information of the codeword (e.g., page 16 of PL3 of the fourth LUN 204-3 for examples involving the first codeword described above in connection with FIG. 2C, and/or page 17 of PL3 of the fourth LUN 204-3 for examples involving the second codeword described above in connection with FIG. 2C).

In this way, memory systems face an inherent balancing between efficient operations and robust defectivity protection. 2WL RAIN may be relatively efficient (e.g., in the example described above in connection with FIG. 2C, the 2WL RAIN procedure may be associated with a parity-to-data ratio of 1:47) and thus may be associated with a relatively low format overhead, but a protection capability of the 2WL RAIN procedure may be relatively low. Block RAIN may be less efficient than 2WL RAIN (e.g., in the example described above in connection with FIG. 2B, the block RAIN procedure may be associated with a parity-to-data ratio of 1:15) and thus may be associated with a higher format overhead than 2WL RAIN, but a protection capability of the block RAIN procedure may be higher than a protection capability of the 2WL RAIN. Die RAIN may be less efficient than both 2WL RAIN and block RAIN (e.g., in the example described above in connection with FIG. 2A, the die RAIN procedure may be associated with a parity-to-data ratio of 1:3) and thus may be associated with a relatively high format overhead, but a protection capability of the die RAIN procedure may be higher than a protection capability of both the 2WL RAIN and the block RAIN.

In this way, for low-density memory systems (e.g., memory systems having a low die count), it may be difficult to employ a strong RAIN scheme such as block RAIN and/or die RAIN, because such RAIN schemes have high overhead (e.g., 6.25%-25% of the dies may be used for parity information rather than host data). Accordingly, in such scenarios, a 2WL RAIN scheme may be the only practical choice in order to achieve the associated block budget. However, 2WL RAIN may result in higher defect rates (e.g., higher defects per million (DPM)) from the component level, and thus may result in a memory system failing to meet certain performance requirements.

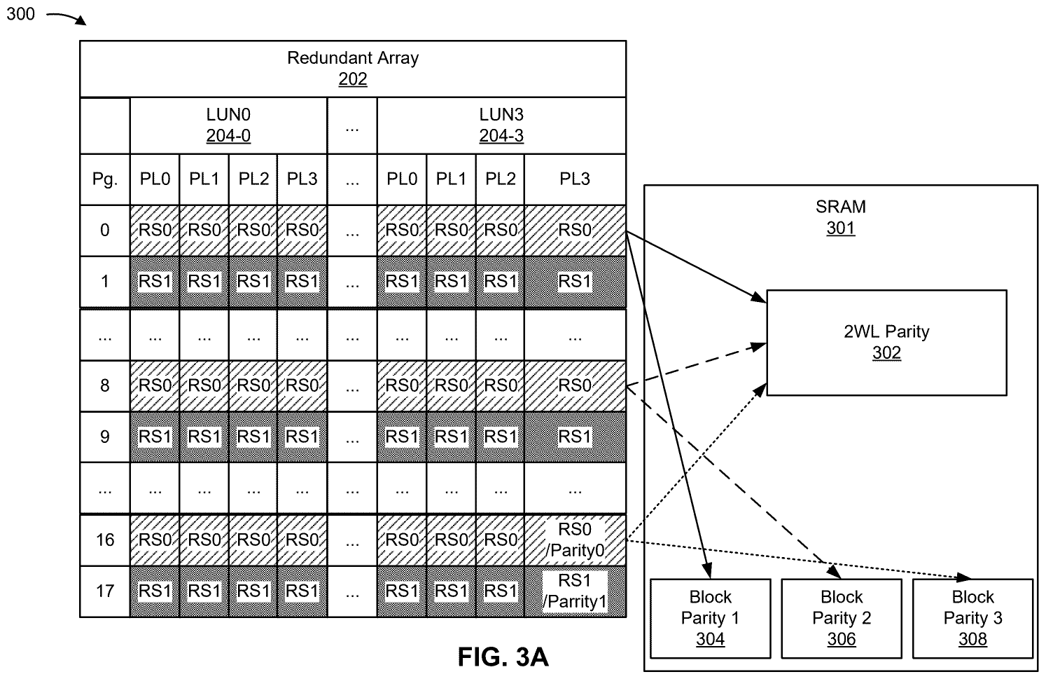

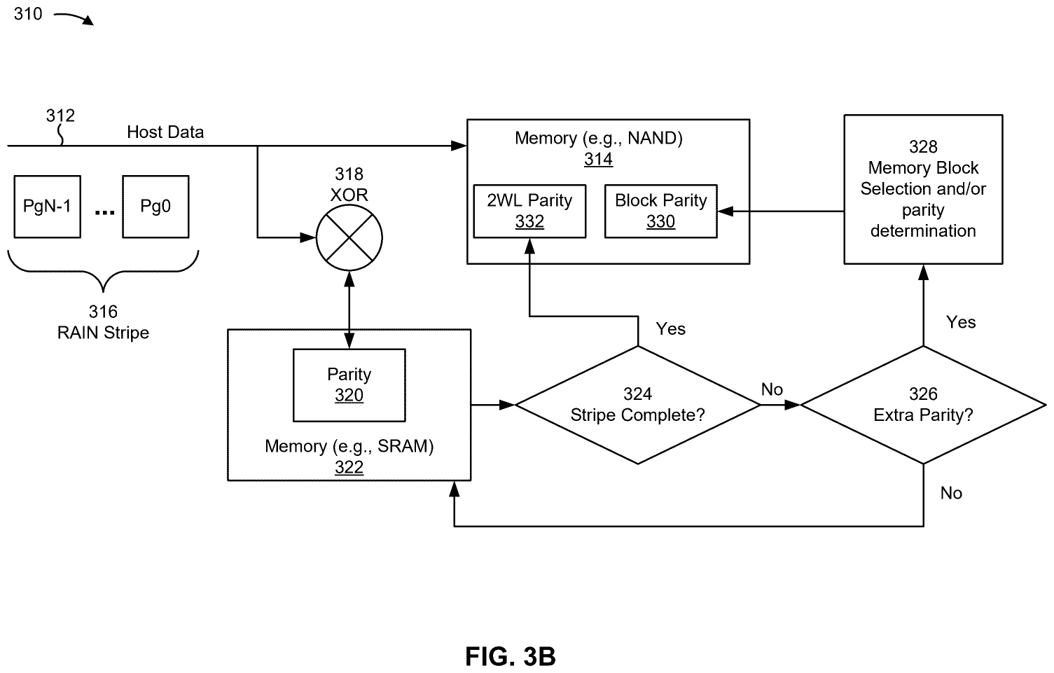

Some implementations and techniques described herein may enable improved protection and/or defect coverage while incurring only moderate format overhead (e.g., as compared to a format overhead associated with a die RAIN scheme or a block RAIN scheme). In some implementations, a memory system may employ a first RAIN scheme (e.g., a 2WL RAIN scheme) for most or all host data, and/or may employ a second RAIN scheme (e.g., a block RAIN scheme) for a subset of the host data, such as for blocks of memory that may be susceptible to failure or defects. In this way, by applying block RAIN for selective blocks (e.g., vulnerable blocks), the memory system may enable improved storage overhead as compared to systems employing die RAIN and/or block RAIN for all host data, while enabling improved protection and/or defect coverage as compared to systems employing only 2WL RAIN for all host data. Aspects of applying block RAIN to selective blocks of memory are described in more detail below in connection with FIGS. 3A-3B.

As indicated above, FIGS. 2A-2D are provided as examples. Other examples may differ from what is described with regard to FIGS. 2A-2D.

FIGS. 3A-3B are diagrams of examples associated with selective implementation of a RAIN procedure. The operations described in connection with FIGS. 3A-3B may be performed by the memory system 110 and/or one or more components of the memory system 110, such as the memory system controller 115, one or more memory devices 120, and/or one or more local controllers 125. As shown in FIGS. 3A-3B, the operations may be associated with a device (e.g., memory system controller 115, among other examples) for receiving host data, determining parity information, and/or applying data protection schemes (RAIN schemes) to portions of a memory (e.g., a NAND memory).

As shown in FIG. 3A, and as indicated by reference number 300, in some implementations the redundant array 202 (or at least a portion of the redundant array 202) may be associated with multiple RAIN schemes and/or procedures, such as a 2WL RAIN procedure as well as a block RAIN procedure. For example, in implementations in which the redundant array 202 is associated with a 2WL RAIN procedure, multiple superpages may form a parity group (e.g., a parity codeword), in a similar manner as described above in connection with FIG. 2C. More particularly, in the example indicated by reference number 300, three superpages form one parity group. For example, all pages associated with page 0, page 8, and page 16 may form a first parity group (with page 0 of PL0 of the first LUN 204-0 through page 16 of PL2 of the fourth LUN 204-3 storing data bits, and with page 16 of PL3 of the fourth LUN 204-3 storing parity bits). Similarly, all pages associated with page 1, page 9, and page 17 may form a second parity group (with page 1 of PL0 of the first LUN 204-0 through page 17 of PL2 of the fourth LUN 204-3 storing data bits, and with page 17 of PL3 of the fourth LUN 204-3 storing parity bits).

In this regard, a memory system and/or a component thereof (e.g., memory system controller 115) may compute parity data as host data associated with the 2WL RAIN stripe is received, and/or may maintain the parity data in a local storage, such as SRAM 301. That is, as shown in FIG. 3A, when data associated with the 48 pages comprising the 2WL RAIN codeword (e.g., the pages of the superpages associated with page 0, page 8, and page 16) are received at the memory system, the system may compute the parity and/or store the updated parity (shown in FIG. 3A as 2WL parity 302) in the SRAM 301. More particularly, and in a similar manner as described above in connection with FIG. 2D, as a page of data associated with the RAIN stripe arrives at the memory system (e.g., from a host system and/or a garbage collection (GC) process, among other examples), the memory system may compute the updated 2WL parity 302 by XORing the new page of data. When all units in the parity group (e.g., the RAIN stripe) have been received and/or XORed, the final parity information may be determined and/or the parity information (e.g., the 2WL parity 302) may be persisted in a non-volatile memory, such as NAND (e.g., memory 216).

In examples in which each parity group (e.g., each RAIN stripe) is associated with an RS codeword, the first 47 pages of each parity group may store data bits of the RS codeword (e.g., the payload of the RS codeword), and the last page of each parity group may store the parity bits of the RS codeword. For example, with respect to the parity group associated with pages 0, 8, and 16, page 0 of PL0 of the first LUN 204-0 through page 16 of PL2 of the fourth LUN 204-3 may store data bits used as a payload of a first RS codeword (and thus labeled “RS0”), and page 16 of PL3 of the fourth LUN 204-3 may store parity bits used as parity information for the first RS codeword (and thus labeled “RS0/Parity0”). Similarly, with respect to the parity group associated with pages 1, 9, and 17, page 1 of PL0 of the first LUN 204-0 through page 17 of PL2 of the fourth LUN 204-3 may store data bits used as a payload of a second RS codeword (and thus labeled “RS1”), and page 17 of PL3 of the fourth LUN 204-3 may store parity bits used as parity information for the second RS codeword (and thus labeled “RS1/Parity1”).

As described above, the redundant array 202 may further be associated with another RAIN procedure, such as a block RAIN procedure (e.g., the block RAIN procedure described above in connection with FIG. 2B). In such implementations, the memory system may further compute parity information associated with the block RAIN procedure as the pages arrive at the memory system. More particularly, in the example shown in FIG. 3A, the 48 pages associated with the first parity group of the 2WL RAIN procedure may also be associated with a block RAIN procedure, with the first 16 pages thereof (e.g., the superpage associated with page 0) belonging to a first parity group associated with the block RAIN procedure, the second 16 pages thereof (e.g., the superpage associated with page 8) belonging to a second parity group associated with the block RAIN procedure, and/or with the third 16 pages thereof (e.g., the superpage associated with page 16) belonging to a third parity group associated with the block RAIN procedure.

More particularly, as a page of data associated with the 2WL RAIN stripe arrives at the memory system (e.g., from a host system and/or a GC process, among other examples), the memory system may compute the updated 2WL parity 302 by XORing the new page of data, as described above, such that the 2WL RAIN parity is fully generated when all 47 pages of data are XORed. However, before the 2WL parity is fully generated, the memory system may generate three sets of block RAIN parity information, one for every 16 pages of the 2WL RAIN stripe. For example, the sixteen pages associated with page 0 in the example shown in FIG. 3A may form a first superpage that is associated with a first block parity 304, the sixteen pages associated with page 8 in the example shown in FIG. 3A may form a second superpage that is associated with a second block parity 306, and/or the sixteen pages associated with page 16 in the example shown in FIG. 3A may form a third superpage that is associated with a third block parity 308. Accordingly, page 0 of PL0 of the first LUN 204-0 through page 0 of PL3 of the fourth LUN 204-3 may form a first parity group, page 8 of PL0 of the first LUN 204-0 through page 8 of PL3 of the fourth LUN 204-3 may form a second parity group, and/or page 16 of PL0 of the first LUN 204-0 through page 16 of PL3 of the fourth LUN 204-3 may form a third parity group. As each set of parity information (e.g., the first block parity 304, the second block parity 306, and/or the third block parity 308) is generated, the memory system may maintain the parity data in a local storage, such as the SRAM 301, and/or the memory system may persist the respective parity information to non-volatile memory (e.g., NAND) when each set is fully generated.

FIG. 3B shows an example 310 associated with the general flow for parity generation for a portion of memory associated with multiple RAIN procedures, such as generation of parity information (e.g., parity bits of a codeword) associated with both a 2WL RAIN procedure and a block RAIN procedure as described above in connection with FIG. 3A, among other examples. As indicated by reference number 312, a memory system may receive, from a host system, host data to be written to a portion of a memory 314 (e.g., a NAND memory). For example, in SSD applications, the host system may transmit data intended for storage to an SSD that utilizes NAND flash memory (e.g., memory 314). The memory system may then map this data to specific portions or blocks of the NAND memory for storage.

In some aspects, the memory system may determine, for the host data, a first set of parity information that is associated with a first RAIN procedure. For instance, this initial RAIN procedure may be one of the die RAIN procedure described above in connection with FIG. 2A, the block RAIN procedure described above in connection with FIG. 2B, and/or the 2WL RAIN procedure described above in connection with FIG. 2C. For example, and in a similar manner as described above in connection with FIG. 2D, as host data is received at a memory system controller, pages of data belonging to a same parity group (e.g., the same RAIN stripe 316, which may correspond to a 2WL RAIN stripe in examples in which the first RAIN procedure is a 2WL RAIN procedure) may be stored in the memory 314 (e.g., a NAND memory) as well as fed to an XOR engine 318 associated with the 2WL RAIN procedure. The XOR engine 318 may perform an XOR operation using the pages of host data as input. More particularly, the XOR engine 318 may continuously update parity information 320 stored in a local memory 322 (e.g., SRAM) as the host data is fed to the XOR engine 318, such as by performing an XOR operation in a bitwise fashion using the various pages of host data as input.

As indicated by reference number 324, the memory system may determine whether the RAIN stripe 316 is complete (e.g., whether all host data for the RAIN stripe 316 has been provided to the XOR engine 318, and thus the XOR engine 318 has concluded the parity information calculations associated with the first RAIN procedure). If the RAIN stripe 316 is not complete, shown as “No” in connection with the operations indicated by reference number 324, the memory system may determine whether the portion of the NAND memory is associated with a second RAIN procedure, different from the first RAIN procedure. For example, returning to the example described above in connection with FIG. 3A, the memory system may determine whether the portion of the NAND memory (e.g., the portion of the NAND memory to which the host data is to be stored) is associated with a block RAIN procedure in addition to the 2WL procedure. If not, shown as “No” in connection with the operations indicated by reference number 326, the process may continue in a like manner as described above in connection with FIG. 2D (e.g., continue to XOR the remaining pages of data and ultimately store the parity data in the memory 314, when the RAIN stripe is complete). However, in implementations in which the portion of the memory is associated with a second RAIN procedure, such as in examples in which the portion of the memory is associated with a block RAIN procedure in addition to the 2WL RAIN procedure (shown as “Yes” in connection with the operations shown by reference number 326), the memory system may proceed to compute extra parity information (e.g., parity information associated with the second RAIN procedure).

In some implementations, the memory system may determine whether the portion of the memory is associated with extra parity (e.g., whether the portion of the memory is associated with a second RAIN procedure) based on certain characteristics of the memory (e.g., the NAND block). For example, the memory system may determine whether the portion of the memory is associated with the second RAIN procedure based on a PEC count associated with the portion of the memory, ERS associated with the portion of the memory, and/or an RBER associated with the portion of the memory, among other characteristics. Put another way, because a protection capability of the second RAIN procedure (e.g., block RAIN) may be higher than a protection capability of the first RAIN procedure (e.g., 2WL RAIN), the memory system may determine whether to use the second RAIN procedure based on whether the portion of the memory is at risk for defects and/or failure by considering a PEC count associated with the portion of the memory, ERS associated with the portion of the memory, and/or an RBER associated with the portion of the memory, among other characteristics.

More particularly, as a number of blocks to be used to store the extra parity (e.g., the parity associated with the extra RAIN procedure) may be limited in the memory 314, the second RAIN procedure may not be employed for all data blocks but, instead, may only be used for selective blocks (e.g., at-risk blocks). In such implementations, the memory system may use a PEC count, ERS, an RBER, and/or similar criteria to determine whether to implement the second RAIN procedure. For example, with respect to PEC, defectivity occurrence may follow a Weibull distribution, in which a portion of memory may have a highest probability of failure in a beginning of life and a lower probability of failure when a component ages (e.g., up to a certain limit, or PEC threshold). Accordingly, the memory system may determine to use the second RAIN procedure for portions of memory that have a low PEC count (e.g., a PEC count below a certain threshold associated with a Weibull distribution curve, among other examples). Moreover, with respect to ERS, the memory system may assume that the more normal and/or non-deep error recoveries that a component experiences, the more likely the component will need a strong RAIN. Accordingly, the memory system may determine to use the second RAIN procedure for portions of memory for which the ERS indicate a high volume of normal and/or non-deep error recoveries. Similarly, with respect to RBER, the memory system may assume that the higher RBER that a component has, the more likely the component will need a strong RAIN. Accordingly, the memory system may determine to use the second RAIN procedure for portions of memory having a relatively high RBER.

In some implementations, the memory system may utilize a histogram or similar data structure in order to facilitate selecting which portions of memory are to be associated with the second RAIN procedure. For example, in implementations in which the memory system determines whether a portion of memory is associated with the second RAIN procedure using ERS and/or an RBER, the memory system may utilize a histogram per block, such as for a purpose of filtering out the first N blocks with high ERS and/or a high RBER, with N corresponding to the quantity of available spare blocks in the memory 314 that may be used to store the extra parity information (e.g., the parity information associated with the second RAIN procedure). Additionally, or alternatively, the memory system may receive, from the host system, configuration information indicating that one or more of the PEC count, the ERS, the RBER, and/or similar criteria are to be used to determine whether the portion of the memory is associated with the second RAIN procedure. This enables dynamic application of a block RAIN method based on configurable criteria that can be modified according to real-time data or preset thresholds.

In implementations in which the memory system determines that the portion of the memory is not associated with a second RAIN procedure (shown as “No” in connection with the operations indicated by reference number 326), the memory system may omit determination of the second set of parity information, and thus proceed in a substantially similar manner as described above in connection with the “No” path of the operations shown by reference number 224 in FIG. 2D. However, in implementations in which the memory system determines that the portion of the memory is associated with a second RAIN procedure (shown as “Yes” in connection with the operations indicated by reference number 326), such as in implementations in which the portion of the memory is identified as having a higher likelihood of defects, the memory system may determine, for the host data, a second set of parity information that is associated with the second RAIN procedure (e.g., block RAIN).

More particularly, as indicated by reference number 328, the memory system may select another portion of the memory 314 (e.g., one or more blocks of the memory 314) for storing the extra parity (e.g., the parity information associated with the second RAIN procedure) and/or determine the extra parity (e.g., using an XOR operation, among other examples). In some aspects, the other portion of the memory 314 may be associated with a grown bad block (GBB) allowance associated with memory 314 and/or an unmapped portion of the memory 314 following a remapping operation of the memory 314, among other examples. For example, in some implementations, the memory system may include a certain quantity of spare blocks that are not budgeted and/or effectively used. These spare blocks may not be counted in the planned over provisioned (OP) blocks in connection with the performance and reliability of the memory system. In such implementations, the quantity of spare blocks may be used to store the extra parity information (e.g., the parity information associated with the second RAIN procedure).

Additionally, or alternatively, one to two extra superblocks may be provided for beginning of life (BOL) of the memory 314 as a GBB allowance. Moreover, during remapping during card initialization, it is seldom the case that there is an extra quantity of blocks to form super blocks without a remainder, resulting in orphaned blocks that may not be remapped to a full superblock. In such implementations, the one to two extra super blocks provided as a GBB allowance and/or the orphaned blocks that are not remapped to a full superblock may result in approximately 20-30 blocks that, in some implementations, may be used to store the extra parity information (e.g., that may be used for the second RAIN procedure). Accordingly, in connection with the operations shown by reference number 328, the memory system may select one or more memory blocks for storing the extra parity information (e.g., the parity information associated with the second RAIN procedure), may compute the extra parity information (e.g., using an XOR operation), and/or may store the extra parity information in the memory 314 at the blocks selected for storing the extra parity information (shown in FIG. 3B as the block parity portion 330 of the memory 314 in FIG. 3B).

The process may proceed in a like manner until the RAIN stripe 316 is fully received at that memory system and thus the parity information associated with the first RAIN procedure (e.g., the 2WL RAIN procedure) is fully computed, shown as “Yes” in connection with the operations shown by reference number 324. At that time, the memory system may store the parity information in the memory 314, shown as a 2WL parity portion 332 of the memory 314 in FIG. 3B. In this way, the techniques described herein may enhance the quality and reliability of memory systems, such as SSDs, while reducing memory resource overhead associated with certain traditional error protection schemes, such as schemes in which storage-intensive error protection schemes like block RAIN or die RAIN are employed for all portions of a memory (e.g., all portions of a NAND memory).

As indicated above, FIGS. 3A-3B are provided as an example. Other examples may differ from what is described with regard to FIGS. 3A-3C.

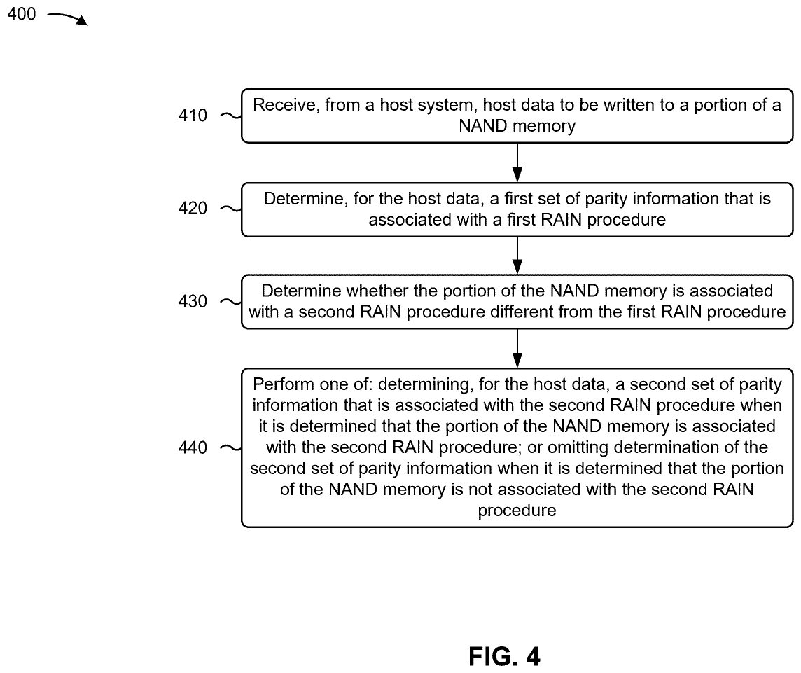

FIG. 4 is a flowchart of an example method 400 associated with selective implementation of a RAIN procedure. In some implementations, a memory system (e.g., the memory system 110) may perform or may be configured to perform the method 400. Additionally, or alternatively, one or more components of the memory system (e.g., the memory system controller 115, one or more memory devices 120, and/or one or more local controllers 125) may perform or may be configured to perform the method 400. Thus, means for performing the method 400 may include the memory system and/or one or more components of the memory system. Additionally, or alternatively, a non-transitory computer-readable medium may store one or more instructions that, when executed by the memory system, cause the memory system to perform the method 400.

As shown in FIG. 4, the method 400 may include receiving, from a host system, host data to be written to a portion of a NAND memory (block 410). For example, the memory system 110 may receive, from the host system 105, the host data described above in connection with reference number 312, which is to be written to a portion (e.g., one or more blocks) of the memory 314.

As further shown in FIG. 4, the method 400 may include determining, for the host data, a first set of parity information that is associated with a first RAIN procedure (block 420). For example, the memory system 110 may determine parity information associated with a 2WL RAIN procedure, as described above in connection with the 2WL parity 302 in FIG. 3A and/or in connection with the XOR engine 318 in FIG. 3B.

As further shown in FIG. 4, the method 400 may include determining whether the portion of the NAND memory is associated with a second RAIN procedure different from the first RAIN procedure (block 430). For example, the memory system 110 may determine whether the portion of the memory 314 is associated with a block RAIN procedure, as described above in connection with reference number 326.

As further shown in FIG. 4, the method 400 may include performing one of: determining, for the host data, a second set of parity information that is associated with the second RAIN procedure when it is determined that the portion of the NAND memory is associated with the second RAIN procedure; or omitting determination of the second set of parity information when it is determined that the portion of the NAND memory is not associated with the second RAIN procedure (block 440). For example, the memory system 110 may determine a second set of parity information (e.g., extra parity information associated with the block RAIN procedure) when it is determined that the portion of the memory is associated with the second RAIN procedure (as described above in connection with the “Yes” path of the operations shown by reference number 326 and/or in connection with reference number 328), or else the memory system 110 may omit determination of the second set of parity information (e.g., extra parity information associated with the block RAIN procedure) when it is determined that the portion of the memory is not associated with the second RAIN procedure (as described above in connection with the “No” path of the operations shown by reference number 326).

The method 400 may include additional aspects, such as any single aspect or any combination of aspects described below and/or described in connection with one or more other methods or operations described elsewhere herein.

In a first aspect, the first RAIN procedure is associated with a 2WL RAIN procedure, and the second RAIN procedure is associated with a block RAIN procedure. For example, the first RAIN procedure may correspond to the 2WL RAIN procedure described above in connection with FIGS. 2C and 3B, and/or the second RAIN procedure may correspond to the block RAIN procedure described above in connection with FIGS. 2B and 3B.

In a second aspect, alone or in combination with the first aspect, a protection capability of the second RAIN procedure is higher than a protection capability of the first RAIN procedure. For example, in implementations in which the first RAIN procedure is a 2WL RAIN procedure and the second RAIN procedure is a block RAIN procedure, the block RAIN procedure (e.g., the RAIN procedure described in connection with FIG. 2B) may have a higher protection capability than the 2WL RAIN procedure (e.g., the RAIN procedure described in connection with FIG. 2C).

In a third aspect, alone or in combination with one or more of the first and second aspects, the method 400 may further comprise storing the second set of parity information in another portion of the NAND memory, wherein the other portion of the NAND memory is associated with at least one of a GBB allowance associated with NAND memory or an unmapped portion of the NAND memory following a remapping operation of the NAND memory. For example, as described above in connection with FIG. 3B, the memory system 110 may store the extra parity information in the block parity portion 330 of the memory 314, which may correspond to spare blocks of the memory 314 associated with a GBB allowance of the memory 314 or an unmapped portion of the memory 314 following a remapping operation of the memory 314.

In a fourth aspect, alone or in combination with one or more of the first through third aspects, determining whether the portion of the NAND memory is associated with the second RAIN procedure includes determining whether the portion of the NAND memory is associated with the second RAIN procedure based on at least one of a PEC count associated with the portion of the NAND memory, ERS associated with the portion of the NAND memory, or an RBER associated with the portion of the NAND memory. For example, as described above in connection with reference number 326, the memory system 110 may determine whether the portion of the memory 314 storing the host data is unreliable and/or otherwise prone to defects based on a PEC count associated with the portion of the memory 314, ERS associated with the portion of the memory 314, an RBER associated with the portion of the memory 314, and/or similar criteria.

In a fifth aspect, alone or in combination with one or more of the first through fourth aspects, the method 400 further comprises receiving, from the host system, configuration information indicating that one or more of the PEC count, the ERS, or the RBER are to be used to determine whether the portion of the NAND memory is associated with the second RAIN procedure. For example, the memory system 110 may receive, from the host system 105, configuration information indicating criteria (e.g., a PEC count, ERS, an RBER, and/or similar criteria) to be used to determine whether a second RAIN procedure is to be used for certain portions of the memory 314.

In a sixth aspect, alone or in combination with one or more of the first through fifth aspects, the host data is associated with a first RAIN stripe associated with the first RAIN procedure, determining whether the portion of the NAND memory is associated with the second RAIN procedure includes determining that the portion of the NAND memory is associated with the second RAIN procedure, the host data is associated with a second RAIN stripe associated with the second RAIN procedure, and a first payload associated with the first RAIN stripe is different than a second payload associated with the second RAIN stripe. For example, when the memory system 110 determines that a portion of the memory 314 storing the host data is associated with the second RAIN procedure (e.g., the block RAIN procedure), the memory system 110 may compute multiple sets of parity information associated with the second RAIN procedure, each associated with a smaller payload as compared to the first RAIN procedure (e.g., the 2WL RAIN procedure), such as one set of parity information for each superpage of data as described above in connection with the first block parity 304 through the third block parity 308.

In a seventh aspect, alone or in combination with one or more of the first through sixth aspects, determining whether the portion of the NAND memory is associated with the second RAIN procedure includes determining that the portion of the NAND memory is associated with the second RAIN procedure, and determining the second set of parity information includes using an XOR operation that uses the host data as an input to the XOR operation. For example, when computing the second set of party information (e.g., the block RAIN parity information), the memory system 110 may use an XOR operation, as described above in connection with reference number 328.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

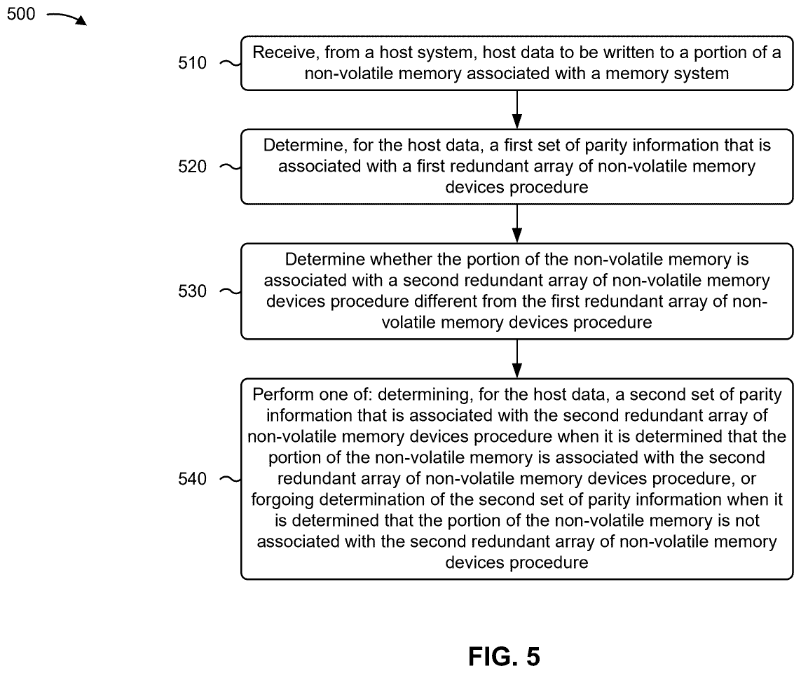

FIG. 5 is a flowchart of another example method 500 associated with selective implementation of a RAIN procedure. In some implementations, a memory system controller (e.g., the memory system controller 115) may perform or may be configured to perform the method 500. In some implementations, another device or a group of devices separate from or including the memory system controller (e.g., memory system 110, one or more memory devices 120, and/or one or more local controllers 125) may perform or may be configured to perform the method 500. Additionally, or alternatively, one or more components of the memory system controller (e.g., a dedicated component and/or engine of the memory system controller 115) may perform or may be configured to perform the method 500. Thus, means for performing the method 500 may include the memory system controller and/or one or more components of the memory system controller. Additionally, or alternatively, a non-transitory computer-readable medium may store one or more instructions that, when executed by the memory system controller, cause the memory system controller to perform the method 500.

As shown in FIG. 5, the method 500 may include receiving, from a host system, host data to be written to a portion of a non-volatile memory associated with a memory system (block 510). For example, the memory system controller 115 may receive, from the host system 105, the host data described above in connection with reference number 312, which is to be written to a portion (e.g., one or more blocks) of the memory 314 (e.g., NAND memory).

As further shown in FIG. 5, the method 500 may include determining, for the host data, a first set of parity information that is associated with a first redundant array of non-volatile memory devices procedure (block 520). For example, the memory system controller 115 may determine parity information associated with a 2WL RAIN procedure, as described above in connection with the 2WL parity 302 in FIG. 3A and/or in connection with the XOR engine 318 in FIG. 3B.

As further shown in FIG. 5, the method 500 may include determining whether the portion of the non-volatile memory is associated with a second redundant array of non-volatile memory devices procedure different from the first redundant array of non-volatile memory devices procedure (block 530). For example, the memory system controller 115 may determine whether the portion of the memory 314 is associated with a block RAIN procedure, as described above in connection with reference number 326.

As further shown in FIG. 5, the method 500 may include performing one of: determining, for the host data, a second set of parity information that is associated with the second redundant array of non-volatile memory devices procedure when it is determined that the portion of the non-volatile memory is associated with the second redundant array of non-volatile memory devices procedure; or forgoing determination of the second set of parity information when it is determined that the portion of the non-volatile memory is not associated with the second redundant array of non-volatile memory devices procedure (block 540). For example, the memory system controller 115 may determine a second set of parity information (e.g., extra parity information associated with the block RAIN procedure) when it is determined that the portion of the memory is associated with the second RAIN procedure (as described above in connection with the “Yes” path of the operations shown by reference number 326 and/or in connection with reference number 328), or else the memory system controller 115 may forgo determination of the second set of parity information (e.g., extra parity information associated with the block RAIN procedure) when it is determined that the portion of the memory is not associated with the second RAIN procedure (as described above in connection with the “No” path of the operations shown by reference number 326).

The method 500 may include additional aspects, such as any single aspect or any combination of aspects described below and/or described in connection with one or more other methods or operations described elsewhere herein.

In a first aspect, the first redundant array of non-volatile memory devices procedure is associated with a 2WL redundant array of non-volatile memory devices procedure, and the second redundant array of non-volatile memory devices procedure is associated with a block redundant array of non-volatile memory devices procedure. For example, the first redundant array of non-volatile memory devices procedure may correspond to the 2WL RAIN procedure described above in connection with FIG. 3B, and/or the second redundant array of non-volatile memory devices procedure may correspond to the block RAIN procedure described above in connection with FIG. 3B.

In a second aspect, alone or in combination with the first aspect, a protection capability of the second redundant array of non-volatile memory devices procedure is higher than a protection capability of the first redundant array of non-volatile memory devices procedure. For example, in implementations in which the first redundant array of non-volatile memory devices procedure is a 2WL RAIN procedure and the second redundant array of non-volatile memory devices procedure is a block RAIN procedure, the block RAIN procedure (e.g., the RAIN procedure described in connection with FIG. 2B) may have a higher protection capability than the 2WL RAIN procedure (e.g., the RAIN procedure described in connection with FIG. 2C).

In a third aspect, alone or in combination with one or more of the first and second aspects, the method 500 includes storing the second set of parity information in another portion of the non-volatile memory, wherein the other portion of the non-volatile memory is associated with at least one of a GBB allowance associated with non-volatile memory, or an unmapped portion of the non-volatile memory following a remapping operation of the non-volatile memory. For example, as described above in connection with FIG. 3B, the memory system controller 115 may store the extra parity information in the block parity portion 330 of the memory 314, which may correspond to spare blocks of the memory 314 associated with a GBB allowance of the memory 314 or an unmapped portion of the memory 314 following a remapping operation of the memory 314.

In a fourth aspect, alone or in combination with one or more of the first through third aspects, determining whether the portion of the non-volatile memory is associated with the second redundant array of non-volatile memory devices procedure includes determining whether the portion of the non-volatile memory is associated with the second redundant array of non-volatile memory devices procedure based on at least one of a PEC count associated with the portion of the non-volatile memory, ERS associated with the portion of the non-volatile memory, or an RBER associated with the portion of the non-volatile memory. For example, as described above in connection with reference number 326, the memory system controller 115 may determine whether the portion of the memory 314 storing the host data is unreliable and/or otherwise prone to defects based on a PEC count associated with the portion of the memory 314, ERS associated with the portion of the memory 314, an RBER associated with the portion of the memory 314, and/or similar criteria.

In a fifth aspect, alone or in combination with one or more of the first through fourth aspects, the method 500 includes receiving, from the host system, configuration information indicating that one or more of the PEC count, the ERS, or the RBER are to be used to determine whether the portion of the non-volatile memory is associated with the second redundant array of non-volatile memory devices procedure. For example, the memory system controller 115 may receive, from the host system 105, configuration information indicating criteria (e.g., a PEC count, ERS, an RBER, and/or similar criteria) to be used to determine whether a second RAIN procedure is to be used for certain portions of the memory 314.

In a sixth aspect, alone or in combination with one or more of the first through fifth aspects, the host data is associated with a redundant array of non-volatile memory devices stripe associated with the first redundant array of non-volatile memory devices procedure, determining whether the portion of the non-volatile memory is associated with the second redundant array of non-volatile memory devices procedure includes determining that the portion of the non-volatile memory is associated with the second redundant array of non-volatile memory devices procedure, and the method 500 further comprises determining, for the second redundant array of non-volatile memory devices procedure, multiple sets of parity information associated with the redundant array of non-volatile memory devices stripe. For example, when the memory system controller 115 determines that a portion of the memory 314 storing the host data is associated with the second redundant array of non-volatile memory devices procedure (e.g., the block RAIN procedure), the memory system controller 115 may compute multiple sets of parity information associated with the second redundant array of non-volatile memory devices procedure, such as one set of parity information for each superpage of data, as described above in connection with the first block parity 304 through the third block parity 308.

In a seventh aspect, alone or in combination with one or more of the first through sixth aspects, determining whether the portion of the non-volatile memory is associated with the second redundant array of non-volatile memory devices procedure includes determining that the portion of the non-volatile memory is associated with the second redundant array of non-volatile memory devices procedure, and determining the second set of parity information includes utilizing an XOR operation that uses the host data as an input to the XOR operation. For example, when computing the second set of party information (e.g., the block RAIN parity information), the memory system controller 115 may use an XOR operation, as described above in connection with reference number 328.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

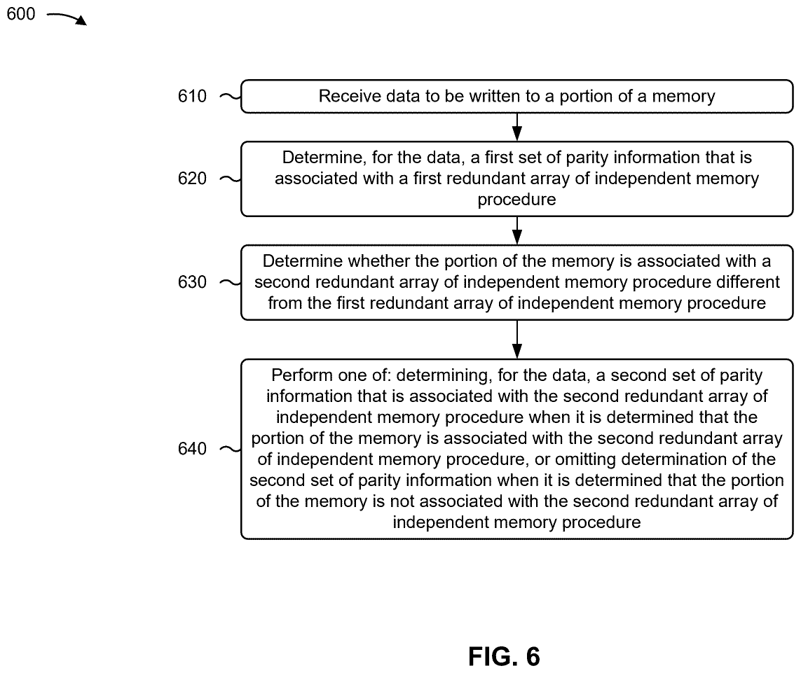

FIG. 6 is a flowchart of another example method 600 associated with selective implementation of a RAIN procedure. In some implementations, a memory system (e.g., the memory system 110) may perform or may be configured to perform the method 600. Additionally, or alternatively, one or more components of the memory system (e.g., memory system controller 115, one or more memory devices 120, and/or one or more local controllers 125) may perform or may be configured to perform the method 600. Thus, means for performing the method 600 may include the memory system and/or one or more components of the memory system. Additionally, or alternatively, a non-transitory computer-readable medium may store one or more instructions that, when executed by the memory system, cause the memory system to perform the method 600.

As shown in FIG. 6, the method 600 may include receiving data to be written to a portion of a memory (block 610). For example, the memory system 110 may receive, from the host system 105, the host data described above in connection with reference number 312, which is to be written to a portion (e.g., one or more blocks) of the memory 314.

As further shown in FIG. 6, the method 600 may include determining, for the data, a first set of parity information that is associated with a first redundant array of independent memory procedure (block 620). For example, the memory system 110 may determine parity information associated with a 2WL RAIN procedure, as described above in connection with the 2WL parity 302 in FIG. 3A and/or in connection with the XOR engine 318 in FIG. 3B.

As further shown in FIG. 6, the method 600 may include determining whether the portion of the memory is associated with a second redundant array of independent memory procedure different from the first redundant array of independent memory procedure (block 630). For example, the memory system 110 may determine whether the portion of the memory 314 is associated with a block RAIN procedure, as described above in connection with reference number 326.

As further shown in FIG. 6, the method 600 may include performing one of: determining, for the data, a second set of parity information that is associated with the second redundant array of independent memory procedure when it is determined that the portion of the memory is associated with the second redundant array of independent memory procedure; or omitting determination of the second set of parity information when it is determined that the portion of the memory is not associated with the second redundant array of independent memory procedure (block 640). For example, the memory system 110 may determine a second set of parity information (e.g., extra parity information associated with the block RAIN procedure) when it is determined that the portion of the memory is associated with the second redundant array of independent memory procedure (as described above in connection with the “Yes” path of the operations shown by reference number 326 and/or in connection with reference number 328), or else the memory system 110 may omit determination of the second set of parity information (e.g., extra parity information associated with the block RAIN procedure) when it is determined that the portion of the memory is not associated with the second redundant array of independent memory procedure (as described above in connection with the “No” path of the operations shown by reference number 326).

The method 600 may include additional aspects, such as any single aspect or any combination of aspects described below and/or described in connection with one or more other methods or operations described elsewhere herein.

In a first aspect, the first redundant array of independent memory procedure is associated with a 2WL redundant array of independent memory procedure, and the second redundant array of independent memory procedure is associated with a block redundant array of independent memory procedure. For example, the first redundant array of independent memory procedure may correspond to the 2WL RAIN procedure described above in connection with FIG. 3B, and/or the second redundant array of independent memory procedure may correspond to the block RAIN procedure described above in connection with FIG. 3B.

In a second aspect, alone or in combination with the first aspect, a protection capability of the second redundant array of independent memory procedure is higher than a protection capability of the first redundant array of independent memory procedure. For example, in implementations in which the first redundant array of independent memory procedure is a 2WL RAIN procedure and the second redundant array of independent memory procedure is a block RAIN procedure, the block RAIN procedure (e.g., the RAIN procedure described in connection with FIG. 2B) may have a higher protection capability than the 2WL RAIN procedure (e.g., the RAIN procedure described in connection with FIG. 2C).

In a third aspect, alone or in combination with one or more of the first and second aspects, the method 600 further comprises storing the second set of parity information in another portion of the memory, wherein the other portion of the memory is associated with at least one of a GBB allowance associated with memory, or an unmapped portion of the memory following a remapping operation of the memory. For example, as described above in connection with FIG. 3B, the memory system 110 may store the extra parity information in the block parity portion 330 of the memory 314, which may correspond to spare blocks of the memory 314 associated with a GBB allowance of the memory 314 or an unmapped portion of the memory 314 following a remapping operation of the memory 314.

In a fourth aspect, alone or in combination with one or more of the first through third aspects, determining whether the portion of the memory is associated with the second redundant array of independent memory procedure includes determining whether the portion of the memory is associated with the second redundant array of independent memory procedure based on at least one of a PEC count associated with the portion of the memory, ERS associated with the portion of the memory, or a RBER associated with the portion of the memory. For example, as described above in connection with reference number 326, the memory system 110 may determine whether the portion of the memory 314 storing the host data is unreliable and/or otherwise prone to defects based on a PEC count associated with the portion of the memory 314, ERS associated with the portion of the memory 314, an RBER associated with the portion of the memory 314, and/or similar criteria.

In a fifth aspect, alone or in combination with one or more of the first through fourth aspects, the method 600 further comprises receiving configuration information indicating that one or more of the PEC count, the ERS, or the RBER are to be used to determine whether the portion of the memory is associated with the second redundant array of independent memory procedure. For example, the memory system 110 may receive, from the host system 105, configuration information indicating criteria (e.g., a PEC count, ERS, an RBER, and/or similar criteria) to be used to determine whether a second RAIN procedure is to be used for certain portions of the memory 314.

In a sixth aspect, alone or in combination with one or more of the first through fifth aspects, the data is associated with a redundant array of independent memory stripe associated with the first redundant array of independent memory procedure, determining whether the portion of the memory is associated with the second redundant array of independent memory procedure includes determine that the portion of the memory is associated with the second redundant array of independent memory procedure, and the method 600 further comprises determining, for the second redundant array of independent memory procedure, multiple sets of parity information associated with the redundant array of independent memory stripe. For example, when the memory system 110 determines that a portion of the memory 314 storing the host data is associated with the second redundant array of independent memory procedure (e.g., the block RAIN procedure), the memory system 110 may compute multiple sets of parity information associated with the second redundant array of independent memory procedure, such as one set of parity information for each superpage of data as described above in connection with the first block parity 304 through the third block parity 308.

In a seventh aspect, alone or in combination with one or more of the first through sixth aspects, determining whether the portion of the memory is associated with the second redundant array of independent memory procedure includes determining that the portion of the memory is associated with the second redundant array of independent memory procedure, and determining the second set of parity information includes using an XOR operation that uses the data as an input to the XOR operation. For example, when computing the second set of party information (e.g., the block RAIN parity information), the memory system 110 may use an XOR operation, as described above in connection with reference number 328.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

In some implementations, a memory system includes one or more components configured to: receive, from a host system, host data to be written to a portion of a NAND memory; determine, for the host data, a first set of parity information that is associated with a first redundant array of independent NAND (RAIN) procedure; determine whether the portion of the NAND memory is associated with a second RAIN procedure different from the first RAIN procedure; and perform one of: determining, for the host data, a second set of parity information that is associated with the second RAIN procedure when it is determined that the portion of the NAND memory is associated with the second RAIN procedure; or omitting determination of the second set of parity information when it is determined that the portion of the NAND memory is not associated with the second RAIN procedure.

In some implementations, a method includes receiving, by a memory system controller and from a host system, host data to be written to a portion of a non-volatile memory associated with a memory system; determining, by the memory system controller and for the host data, a first set of parity information that is associated with a first redundant array of non-volatile memory devices procedure; determining, by the memory system controller, whether the portion of the non-volatile memory is associated with a second redundant array of non-volatile memory devices procedure different from the first redundant array of non-volatile memory devices procedure; and performing one of: determining, by the memory system controller and for the host data, a second set of parity information that is associated with the second redundant array of non-volatile memory devices procedure when it is determined that the portion of the non-volatile memory is associated with the second redundant array of non-volatile memory devices procedure; or forgoing, by the memory system controller, determination of the second set of parity information when it is determined that the portion of the non-volatile memory is not associated with the second redundant array of non-volatile memory devices procedure.

In some implementations, a memory system includes one or more components configured to: receive data to be written to a portion of a memory; determine, for the data, a first set of parity information that is associated with a first redundant array of independent memory procedure; determine whether the portion of the memory is associated with a second redundant array of independent memory procedure different from the first redundant array of independent memory procedure; and perform one of: determining, for the data, a second set of parity information that is associated with the second redundant array of independent memory procedure when it is determined that the portion of the memory is associated with the second redundant array of independent memory procedure; or omitting determination of the second set of parity information when it is determined that the portion of the memory is not associated with the second redundant array of independent memory procedure.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more components configured to:
receive, from a host system, host data to be written to a portion of a NAND memory;
determine, for the host data, a first set of parity information that is associated with a first redundant array of independent NAND (RAIN) procedure;
determine whether the portion of the NAND memory is associated with a second RAIN procedure different from the first RAIN procedure; and
perform one of:
determining, for the host data, a second set of parity information that is associated with the second RAIN procedure when it is determined that the portion of the NAND memory is associated with the second RAIN procedure; or
omitting determination of the second set of parity information when it is determined that the portion of the NAND memory is not associated with the second RAIN procedure.

2. The memory system of claim 1, wherein the first RAIN procedure is associated with a two-word-line RAIN procedure, and
wherein the second RAIN procedure is associated with a block RAIN procedure.

3. The memory system of claim 1, wherein a protection capability of the second RAIN procedure is higher than a protection capability of the first RAIN procedure.

4. The memory system of claim 1, wherein the one or more components are further configured to store the second set of parity information in another portion of the NAND memory,
wherein the other portion of the NAND memory is associated with at least one of:
a grown bad block allowance associated with NAND memory, or
an unmapped portion of the NAND memory following a remapping operation of the NAND memory.

5. The memory system of claim 1, wherein the one or more components, to determine whether the portion of the NAND memory is associated with the second RAIN procedure, are configured to determine whether the portion of the NAND memory is associated with the second RAIN procedure based on at least one of:
a program-erase cycle (PEC) count associated with the portion of the NAND memory,
error recovery statistics (ERS) associated with the portion of the NAND memory, or
a raw bit error rate (RBER) associated with the portion of the NAND memory.

6. The memory system of claim 5, wherein the one or more components are further configured to receive, from the host system, configuration information indicating that one or more of the PEC count, the ERS, or the RBER are to be used to determine whether the portion of the NAND memory is associated with the second RAIN procedure.

7. The memory system of claim 1, wherein the host data is associated with a first RAIN stripe associated with the first RAIN procedure,
wherein the one or more components, to determine whether the portion of the NAND memory is associated with the second RAIN procedure, are configured to determine that the portion of the NAND memory is associated with the second RAIN procedure,
wherein the host data is associated with a second RAIN stripe associated with the second RAIN procedure, and
wherein a first payload associated with the first RAIN stripe is different than a second payload associated with the second RAIN stripe.

8. The memory system of claim 1, wherein the one or more components, to determine whether the portion of the NAND memory is associated with the second RAIN procedure, are configured to determine that the portion of the NAND memory is associated with the second RAIN procedure, and
wherein the one or more components, to determine the second set of parity information, are configured to use an exclusive or (XOR) operation that uses the host data as an input to the XOR operation.

9. A method, comprising:
receiving, by a memory system controller and from a host system, host data to be written to a portion of a non-volatile memory associated with a memory system;
determining, by the memory system controller and for the host data, a first set of parity information that is associated with a first redundant array of non-volatile memory devices procedure;
determining, by the memory system controller, whether the portion of the non-volatile memory is associated with a second redundant array of non-volatile memory devices procedure different from the first redundant array of non-volatile memory devices procedure; and
performing one of:
determining, by the memory system controller and for the host data, a second set of parity information that is associated with the second redundant array of non-volatile memory devices procedure when it is determined that the portion of the non-volatile memory is associated with the second redundant array of non-volatile memory devices procedure; or
forgoing, by the memory system controller, determination of the second set of parity information when it is determined that the portion of the non-volatile memory is not associated with the second redundant array of non-volatile memory devices procedure.

10. The method of claim 9, wherein the first redundant array of non-volatile memory devices procedure is associated with a two-word-line redundant array of non-volatile memory devices procedure, and
wherein the second redundant array of non-volatile memory devices procedure is associated with a block redundant array of non-volatile memory devices procedure.

11. The method of claim 9, wherein a protection capability of the second redundant array of non-volatile memory devices procedure is higher than a protection capability of the first redundant array of non-volatile memory devices procedure.

12. The method of claim 9, further comprising storing, by the memory system controller, the second set of parity information in another portion of the non-volatile memory,
wherein the other portion of the non-volatile memory is associated with at least one of:
a grown bad block allowance associated with non-volatile memory, or
an unmapped portion of the non-volatile memory following a remapping operation of the non-volatile memory.

13. The method of claim 9, wherein determining whether the portion of the non-volatile memory is associated with the second redundant array of non-volatile memory devices procedure includes determining whether the portion of the non-volatile memory is associated with the second redundant array of non-volatile memory devices procedure based on at least one of:
a program-erase cycle (PEC) count associated with the portion of the non-volatile memory,
error recovery statistics (ERS) associated with the portion of the non-volatile memory, or
a raw bit error rate (RBER) associated with the portion of the non-volatile memory.

14. The method of claim 13, further comprising receiving, by the memory system controller from the host system, configuration information indicating that one or more of the PEC count, the ERS, or the RBER are to be used to determine whether the portion of the non-volatile memory is associated with the second redundant array of non-volatile memory devices procedure.

15. The method of claim 9, wherein the host data is associated with a redundant array of non-volatile memory devices stripe associated with the first redundant array of non-volatile memory devices procedure,
wherein determining whether the portion of the non-volatile memory is associated with the second redundant array of non-volatile memory devices procedure includes determining that the portion of the non-volatile memory is associated with the second redundant array of non-volatile memory devices procedure, and wherein the method further comprises determining, by the memory system controller and for the second redundant array of non-volatile memory devices procedure, multiple sets of parity information associated with the redundant array of non-volatile memory devices stripe.

16. The method of claim 9, wherein determining whether the portion of the non-volatile memory is associated with the second redundant array of non-volatile memory devices procedure includes determining that the portion of the non-volatile memory is associated with the second redundant array of non-volatile memory devices procedure, and
wherein determining the second set of parity information includes utilizing an exclusive or (XOR) operation that uses the host data as an input to the XOR operation.

17. A memory system, comprising:
one or more components configured to:
receive data to be written to a portion of a memory;
determine, for the data, a first set of parity information that is associated with a first redundant array of independent memory procedure;
determine whether the portion of the memory is associated with a second redundant array of independent memory procedure different from the first redundant array of independent memory procedure; and
perform one of:
determining, for the data, a second set of parity information that is associated with the second redundant array of independent memory procedure when it is determined that the portion of the memory is associated with the second redundant array of independent memory procedure; or
omitting determination of the second set of parity information when it is determined that the portion of the memory is not associated with the second redundant array of independent memory procedure.

18. The memory system of claim 17, wherein the first redundant array of independent memory procedure is associated with a two-word-line redundant array of independent memory procedure, and
wherein the second redundant array of independent memory procedure is associated with a block redundant array of independent memory procedure.

19. The memory system of claim 17, wherein a protection capability of the second redundant array of independent memory procedure is higher than a protection capability of the first redundant array of independent memory procedure.

20. The memory system of claim 17, wherein the one or more components are further configured to store the second set of parity information in another portion of the memory,
wherein the other portion of the memory is associated with at least one of:
a grown bad block allowance associated with memory, or
an unmapped portion of the memory following a remapping operation of the memory.

21. The memory system of claim 17, wherein the one or more components, to determine whether the portion of the memory is associated with the second redundant array of independent memory procedure, are configured to determine whether the portion of the memory is associated with the second redundant array of independent memory procedure based on at least one of:
a program-erase cycle (PEC) count associated with the portion of the memory,
error recovery statistics (ERS) associated with the portion of the memory, or
a raw bit error rate (RBER) associated with the portion of the memory.

22. The memory system of claim 21, wherein the one or more components are further configured to receive configuration information indicating that one or more of the PEC count, the ERS, or the RBER are to be used to determine whether the portion of the memory is associated with the second redundant array of independent memory procedure.

23. The memory system of claim 17, wherein the data is associated with a redundant array of independent memory stripe associated with the first redundant array of independent memory procedure,
wherein the one or more components, to determine whether the portion of the memory is associated with the second redundant array of independent memory procedure, are configured to determine that the portion of the memory is associated with the second redundant array of independent memory procedure, and
wherein the one or more components are further configured to determine, for the second redundant array of independent memory procedure, multiple sets of parity information associated with the redundant array of independent memory stripe.

24. The memory system of claim 17, wherein the one or more components, to determine whether the portion of the memory is associated with the second redundant array of independent memory procedure, are configured to determine that the portion of the memory is associated with the second redundant array of independent memory procedure, and
wherein the one or more components, to determine the second set of parity information, are configured to use an exclusive or (XOR) operation that uses the data as an input to the XOR operation.
